(19) United States
(12) Patent Application Publication
(10) Pub. No.: US 2014/0360597 A1
(43) Pub. Date: Dec. 11, 2014

(54) DOUBLE SECURITY LOCKABLE HYDRAULIC VALVE

(71) Applicants: Michael NEUMARK, Shimshit (IL); Itzhak Menahem GILL, Kiryat Tivon (IL); Yehuda BARUCH, Rishon LeZiyyon (IL); Yakov BACHAR, Rishon LeZiyyon (IL)

(72) Inventors: Michael NEUMARK, Shimshit (IL); Itzhak Menahem GILL, Kiryat Tivon (IL); Yehuda BARUCH, Rishon LeZiyyon (IL); Yakov BACHAR, Rishon LeZiyyon (IL)

(21) Appl. No.: 13/911,111

(22) Filed: Jun. 6, 2013

(51) Int. Cl. F16K 35/00

(52) U.S. Cl. CPC F16K 35/00
USPC 137/383

(57) ABSTRACT

A lockable hydraulic valve for preventing unauthorized use of a system, machinery item or vehicle requiring operation by both electric and hydraulic circuits. The valve comprising a housing provided with a spool bore and at least one hydraulic inlet and at least one hydraulic outlet. A spool allows oil passage from inlet to outlet in a first spool position. A key can drive the spool 90 degrees from a second, locked position to a first open position. A lock member in a hollow provided in the solid housing, engages and revolves the spool and also serves to block access to the exposed end of the spool. A locator member prevents axial movement of the spool member and locates in a spool groove. A non-central spool projection projects outward and operates at least one electric switch to immobilize at least one essential electric circuit simultaneously to the blocking of oil flow.

### BACKGROUND OF THE INVENTION

Most car owners are well aware of the danger of vehicle theft and make use of any or several of the well-known devices to deter those seeking to take possession of their vehicle. As is well known the incidence of car thefts has been reduced but not eliminated and either the owner or the insurance company suffers a substantial loss when a theft occurs.

A major application of the valve described in the present document is for the protection of off-road vehicles It should be noted that a lockable hydraulic valve providing a very high degree of security is also required for certain non-civilian applications. Such a valve can serve well in military-related applications as in tanks and for the operation of the heavy doors found at the top of intercontinental missile silos.

With regard to off-road vehicles, tractors, earth-moving and quarrying machinery, there is much less awareness that these vehicles have in recent years become targets for professional thieves, causing a loss to the owner or insurance company which may far exceed the value of even a luxury automobile. Vehicles of this type almost always are hydraulically operated and the electric circuits needed for operation are provided by the manufacturer with an ignition lock similar to that found on automobiles. As many car-owners have discovered to their cost, an ignition lock alone is not an effective safeguard and can be overcome relatively quickly by someone technically familiar with the vehicle.

A lockable hydraulic valve inserted in an essential circuit can provide a reasonable safeguard against unauthorized activation of hydraulically driven vehicles. Such valves have a spool member riding in the core of a metal housing. When the spool is locked an essential oil passage is blocked.

A method of theft which has not yet been defeated is the provision and connection of a hydraulic by-pass, either having the same function as the lockable hydraulic valve installed on the vehicle or machine, or simply a connector tube to allow oil passage between the blocked ports. Disconnecting the hydraulic pipes from the locked valve and reconnecting said pipes to an unauthorized by-pass brought to the site by thieves is a procedure which can be carried out fairly easily. The result of by-passing the locked valve means that only the standard ignition lock remains to safeguard the vehicle.

Recent patents relating to lockable hydraulic valves are seen in U.S. Pat. No. 6,148,851 to Friedtline, U.S. Pat. No. 7,967,024 to Dosedel, and US Patent Application no. 2009/0057584 by Krulick. All these valves can be overcome by hydraulic by-passing, and thus do not provide the degree of security required for the protection of high-value or high-security equipment.

### SUMMARY OF THE INVENTION

It is therefore one of the objects of the present invention to obviate the weaknesses of prior art lockable hydraulic valves and to provide a valve which retains all the security features described in my previous patent and provides increased security features as will be detailed.

It is a further object of the present invention to provide a lockable hydraulic valve which will prevent operation of the protected machinery item even if said valve is hydraulically by-passed.

The present invention achieves the above objects by providing a lockable hydraulic valve for preventing unauthorized use of a system, machinery item or vehicle requiring operation by both electric and hydraulic circuits, said valve comprising a housing provided with a spool bore and at least one hydraulic inlet and at least one hydraulic outlet; a spool member being positioned in said spool bore, having a first extremity and an opposite second extremity and being provided with at least one oil passage allowing free flow from said at least one hydraulic inlet to said at least one hydraulic outlet in a first spool position, said spool member being revolvable to a second spool position in which at least one of said oil passages is blocked, said spool member being lockable in said second position; a lock member insertable into a hollow provided in said solid housing, a central portion of said lock member being provided with key means for engaging and revolving said spool member, said lock member having actuation means to lock and release said spool member when said spool member has been revolved to said second position; means for preventing axial movement of said spool member after said spool member is correctly positioned inside said spool bore; a non-central spool projection rigidly attached to said second extremity of said spool member and projecting outward therefrom; at least one electric switch member rigidly supported proximate to said non-central spool projection, said switch member being electrically connectable to immobilize an essential electric circuit of said system, machinery item or vehicle, said at least one switch member being operated by said non-central spool projection as said spool member is revolved to/from its said second position, and closure means preventing access to said second extremity and to said at least one electric switch member.

In a preferred embodiment of the present invention there is provided a valve wherein axial movement of said spool member is restricted by a locator element, the outer face thereof blending smoothly with the outer face of said solid housing and being rigidly retained in said housing and projecting partially into said spool bore, while said spool member is provided with a groove extending around a portion of said spool, said groove being disposed in the portion of said spool which is normally hidden by said solid housing, said groove being positioned and dimensioned to allow said spool member to be freely revolved between said first and said second positions.

In another preferred embodiment of the present invention there is provided a valve further provided with a spool passage allowing axial removal of said locator element through a housing passage only when said spool member is in its said first position.

In a further preferred embodiment of the present invention there is provided a valve wherein two electric switch members are provided, one of which can be connected to an ignition circuit while the remaining switch member can be connected to a circuit used to drive an electrically driven fuel pump.

In yet a further preferred embodiment of the present invention there is provided a valve wherein said electric switch members are proximity switches.

In another preferred embodiment of the present invention there is provided a valve wherein a lock member is an electrically operated actuator.

In a most preferred embodiment of the present invention there is provided a valve wherein said lock member serves to block any outside access to said first extremity of said spool member.

It will thus be realized that the novel device of the present invention serves to increase the degree of security provided for vehicle and other applications where a high degree of security is necessary and is provided by modifications to the design of a standard hydraulic valve. The additional cost of the security features is moderate and readily justified when it is needed to protect a high-cost or high-security item, whether mobile or not.

The features described eliminate the possibility of hammering the spool to achieve its axial removal. Turning the spool is possible only by use of the key, or in an electrical embodiment by knowledge of the user name and password. Installation of an unauthorized hydraulic by-pass will free the hydraulic system but not the electrical systems.

While in the drawings there will be seen a 3-way valve. It should however be noted that the present invention is applicable to any hydraulic spool valve, 2 way, 4 way 5 way etc.

The invention will now be described further with reference to the accompanying drawings, which represent by example preferred embodiments of the invention. Structural details are shown only as far as necessary for a fundamental understanding thereof. The described examples, together with the drawings, will make apparent to those skilled in the art how further forms of the invention may be realized.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a perspective non-detailed view of a preferred embodiment of the valve according to the invention;

FIG. 2a is a partially sectioned elevational view of a the spool positioned in the valve body;

FIG. 2b is a cross sectional view of an embodiment showing a removable locator member;

FIG. 3 is a partially sectioned fragmented elevational view of an embodiment fitted with a cylinder lock;

FIG. 4 is a diagrammatic view of an embodiment wherein the switches cut the ignition and the fuel pump circuits;

FIG. 5 is the same as FIG. 4 except that the switches are proximity switches, and

FIG. 6 is a plan view of an electrically operated embodiment.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

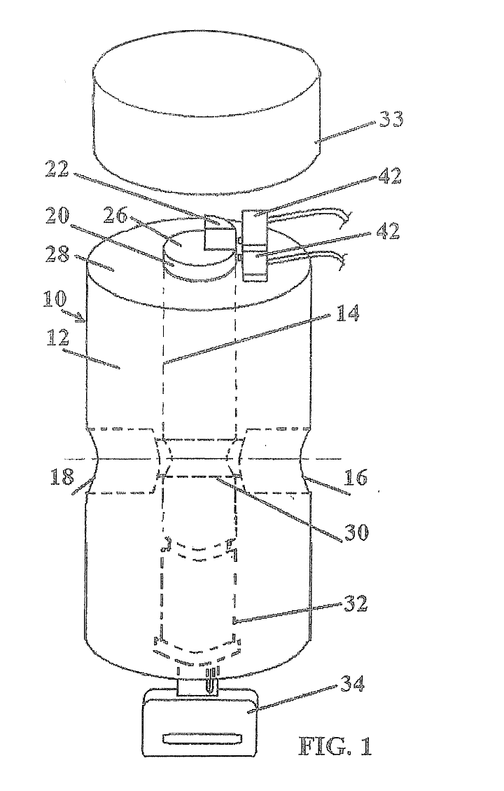

There is seen in non-detailed form in FIG. 1 a lockable hydraulic valve 10 for preventing unauthorized use of a system, machinery item or vehicle requiring operation by both electric and hydraulic circuits.

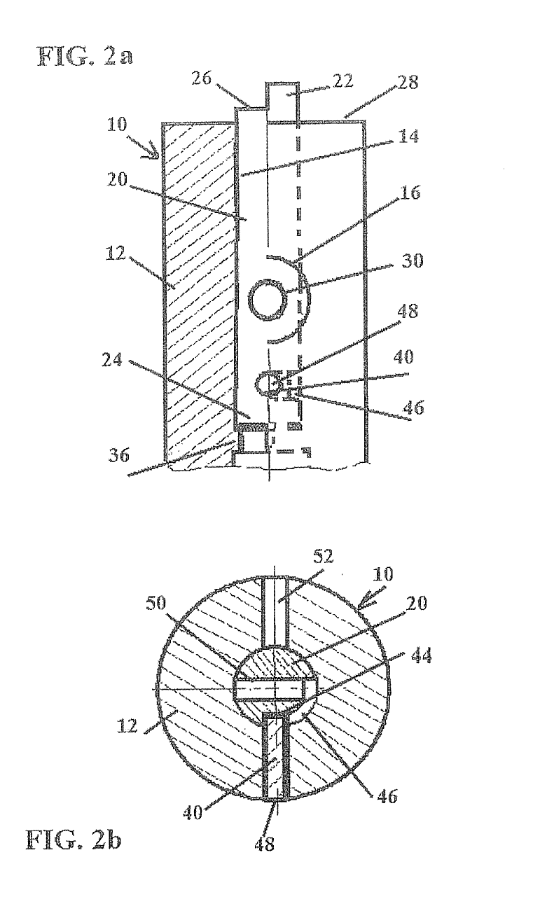

A solid housing 12 is provided with a spool bore 14 and a hydraulic inlet 16 and a hydraulic outlet 18. A spool member 20 is positioned in the spool bore 14. A first extremity 24 of the spool member is seen in FIG. 2a. An opposite second extremity 26 is seen proximate to the upper face 28 of the housing 12. The spool member 20 is traversed by an oil passage 30 which allows free flow between the inlet 16 and outlet 18 when the spool member 20 is in its first spool position as seen in the present drawing.

The spool member 20 is revolvable about 90 degrees to a second position in which the spool member 20 blocks both the inlet 16 and outlet 18 because the oil passage 30 is then unaligned with either the inlet or the outlet.

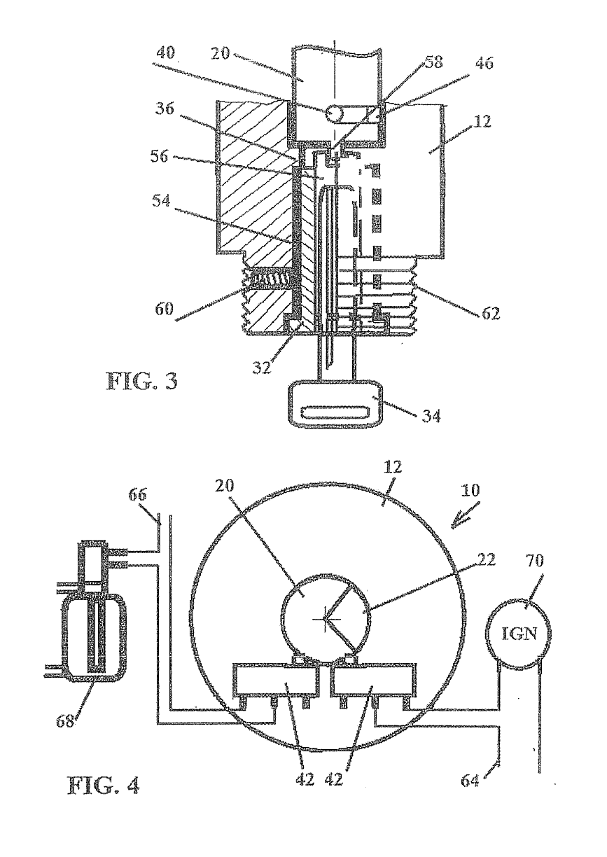

A lock member 32, better seen and described with reference to FIG. 3, is held inside the solid housing 12, and is operated by a key 34. As will be seen in FIG. 3, the lock member 32 is coupled to the spool member 20 and by use of the key 34 the spool member can be revolved to the second position and then locked. Unlocking of the valve 10 is effected by using the key 34 to turn the spool member 20 back to its first position.

Several means are provided for preventing axial movement of the spool member 20 after the spool member 20 is correctly positioned inside the spool bore 14. The spool member 12 cannot be forced axially downwards in the direction of the key 34 because of a shoulder 36, seen in FIGS. 2a and 3, inside the spool bore 14. The spool member 12 cannot be forced upwards, above the upper face 28, because of a locator element 40 seen in FIG. 2b, and also because in a preferred embodiment there is no access to the spool first extremity 24 of the spool member 20 as illustrated in FIG. 3, access being completely blocked by the lock member 32.

A moving non-central spool projection 22 is rigidly attached and projects outward from the second extremity 26 of the spool member 20. The projection 22 operates the electric switch members 42 which are rigidly supported by the housing 12 proximate to the projection 22. The switch members 42 are suitable for connection to immobilize any essential electric circuit of the system, machinery item or vehicle.

Thus when the spool member 20 is revolved to its second position the switch members 42 are in their off state because they are in contact with the projection 22, thereby cutting one circuit in two separate locations or two different electric circuits needed for operation of the device being protected.

The valve 10 is normally located in a location where there is no access to the projection 22 and the switch members 42. However a closure 33 can be fitted to the housing 12 and attached thereto in a manner preventing its ready removal, for example by brazing or by a shrink fit. Closure 33 may prevent access to said second extremity and to said at least one electric switch member.

With reference to the rest of the figures, similar reference numerals have been used to identify similar parts.

Referring now to FIGS. 2a and 2b, there are seen further details of the valve 10. As can be seen from the drawings, axial movement of the spool member 20 is inhibited by a locator element 40, which is a light press fit in the solid body 12. The inner extremity 44 of the locator element 40 engages a spool groove 46 extending around a portion of the spool member 20 preventing axial motion of the spool member 20. The outer face 48 of the locator element 40 blends smoothly with the outer face of the solid housing 12 and there is no gripping surface to allow pulling out thereof. The groove 46 is disposed in the portion of the spool member 20 which is normally hidden by the solid housing 12, the groove 46 being positioned and dimensioned to allow the spool member 20 to be freely revolved between the first and the second positions.

The locator element 40 cannot be pushed out due to the inner extremity 44 abutting the bottom of the groove 46.

Preferably means are provided to allow removal of the locator element 40 for maintenance purposes, but only when the spool member 20 is in its first spool position as seen in FIG. 1. For this purpose a passage 50 in the spool member 20, seen in FIG. 2b, and a passage 52 in the solid housing 12 is provided allowing the locator element 40 to be pushed out through the spool member 20 and through the solid housing 12 only when the spool member 20 is in its the first position.

FIG. 2b shows the spool member 20 in its second position wherein removal of the locator element 40 is not possible.

A lock member 32, seen in FIG. 3, is held inside a hollow 54 inside the solid housing 12. thus completely blocking axial access to the spool member 12 and therefore preventing any attempt to force the spool member 20 in a direction away from removable key means 34. The central revolvable portion 56 of the lock member 32 can be revolved by key 34. The portion 56 engages a tongue projection 58 integral to the spool member 20. Thus by turning the key 34 it is possible to revolve the spool member 20 between its first and second spool rotary positions.

A screw 60 retaining the lock member 32 is invisible and inaccessible when the valve 10 is held in a casing or by a bracket (not shown) by means of a threaded portion 62 of the solid housing 12.

Seen in FIG. 4 is a detail of the valve 10 shown with the spool member 20 in its first position. Two normally-on electric switch members 42 are mounted on the solid housing 12. One switch member 42 is seen connected to an ignition circuit 64 while the remaining switch member 42 is seen connected to a circuit 66 used to operate an electrically driven fuel pump 68. The switch members 42 are positioned so that the moving non-central spool projection 22 operates both the electric switch members 42 when the spool member 20 is in its second position blocking oil flow.

Thus the vehicle/equipment cannot be operated by unauthorized persons who might install a hydraulic by-pass, as the ignition circuit 64 remains broken in 2 places, once by the ignition switch 70 which is standard equipment and in another location by a switch 42, and the fuel supply circuit 66 is interrupted by the remaining switch 42.

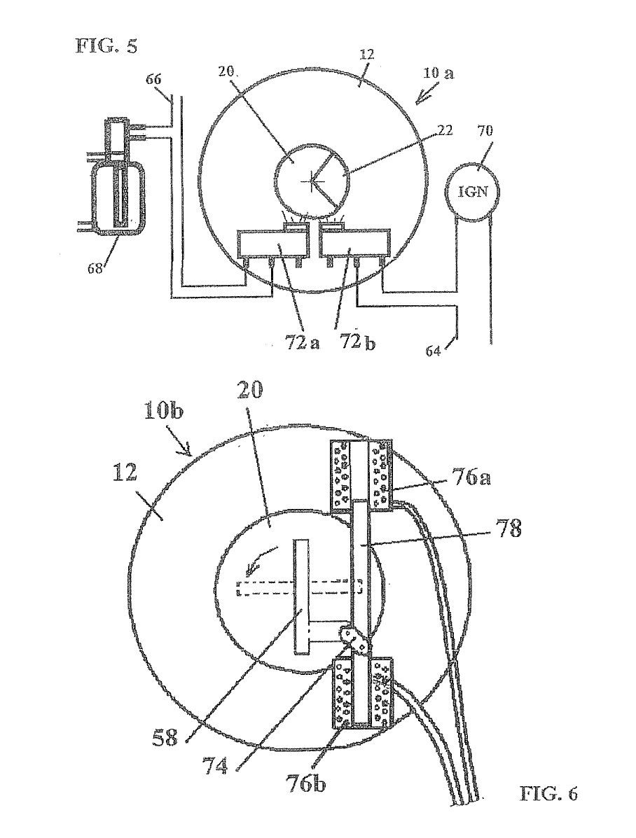

Referring now to FIG. 5, there is depicted details of a valve 10a which is identical to the valve 10 seen and described with reference to FIG. 4, except that the two normally-on electric switch members 72 are proximity switches. The switches are thus positioned a little further away from the moving non-central spool projection 22. The lack of mechanical contact between the switches 72 and the projection 22 reduces the torque needing to be applied by the authorized operator when turning the key 34 seen in FIG. 1 and extends the operating life of the switches 72.

FIG. 6 shows an embodiment for use in applications where the user prefers electronic locking using a user name and a password instead of the mechanical key and lock seen in FIG. 3. In the present embodiment the spool tongue 58 is driven through a link 74 by a pair of solenoids 76a 76b sharing a common plunger 78. The valve 10b is locked by supplying electric power for a few seconds to solenoid 76a and is unlocked by supplying electric power for a few seconds to solenoid 76b.

As is known, there are other possible arrangements for electrically turning a shaft by 90 degrees, for example step motors and rotary solenoids, the present embodiment merely illustrates an example of a suitable electro-mechanical assembly achieving this end.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A lockable hydraulic valve for preventing unauthorized use of a system, machinery item or vehicle requiring operation by both electric and hydraulic circuits, said valve comprising
a housing provided with a spool bore and at least one hydraulic inlet and at least one hydraulic outlet;
a spool member being positioned in said spool bore, having a first extremity and an opposite second extremity and being provided with at least one oil passage allowing free flow from said at least one hydraulic inlet to said at least one hydraulic outlet in a first spool position, said spool member being revolvable to a second spool position in which at least one of said oil passages is blocked, said spool member being lockable in said second position;
a lock member insertable into a hollow provided in said solid housing, a central portion of said lock member being provided with key means for engaging and revolving said spool member, said lock member having actuation means to lock and release said spool member when said spool member has been revolved to said second position;
means for preventing axial movement of said spool member after said spool member is correctly positioned inside said spool bore;
a non-central spool projection rigidly attached to said second extremity of said spool member and projecting outward therefrom;
at least one electric switch member rigidly supported proximate to said non-central spool projection, said switch member being electrically connectable to immobilize an essential electric circuit of said system, machinery item or vehicle, said at least one switch member being operated by said non-central spool projection as said spool member is revolved to/from its said second position, and
closure means preventing access to said second extremity and to said at least one electric switch member.

2. The valve as claimed in claim 1, wherein axial movement of said spool member is restricted by a locator element, the outer face thereof blending smoothly with the outer face of said solid housing and being rigidly retained in said housing and projecting partially into said spool bore, while said spool member is provided with a groove extending around a portion of said spool, said groove being disposed in the portion of said spool which is normally hidden by said solid housing, said groove being positioned and dimensioned to allow said spool member to be freely revolved between said first and said second positions.

3. The valve as claimed in claim 1, wherein said lock member serves to block any outside access to said first extremity of said spool member.

4. The valve as claimed in claim 2 further provided with a spool passage allowing axial removal of said locator element through a housing passage only when said spool member is in its said first position.

5. The valve as claimed in claim 1, wherein two electric switch members are provided, one of which can be connected to an ignition circuit while the remaining switch member can be connected to a circuit used to drive an electrically driven fuel pump.

6. The valve as claimed in claim 1, wherein said electric switch members are proximity switches.

7. The valve as claimed in claim 1, wherein said lock member is a cylinder lock.

8. The valve as claimed in claim 1, wherein said lock member is an electrically operated actuator.
